(19) United States
(12) Patent Application Publication
(10) Pub. No.: US 2021/0372324 A1
(43) Pub. Date: Dec. 2, 2021

(54) Detonation Engine having a Discontinuous Detonation Chamber

(71) Applicant: Purdue Research Foundation, West Lafayette, IN (US)

(72) Inventors: Carson Daniel Slabaugh, West Lafayette, IN (US); Rohan Madhav Gejji, West Lafayette, IN (US); Kyle S. Schwinn, West Lafayette, IN (US); Stephen D. Heister, West Lafayette, IN (US); Swanand V. Sardeshmukh, West Lafayette, IN (US)

(21) Appl. No.: 17/213,740

(22) Filed: Mar. 26, 2021

Related U.S. Application Data
(60) Provisional application No. 63/032,098, filed on May 29, 2020.

(51) Int. Cl. F02C 5/10; F02M 57/00

(52) U.S. Cl. CPC F02C 5/10; F05D 2220/323; F02M 57/00

(57) ABSTRACT

A detonation engine includes at least one chamber wall and a first detonation chamber defined by the at least one chamber wall, the first detonation chamber having a first end and a second end. The first detonation chamber is linear, curved, or includes a plurality of detonation chamber segments that are linear and/or curved, and the detonation engine is configured such that detonation repeatedly propagates from the first end of the first detonation chamber to the second end of the first detonation chamber.

### CROSS-REFERENCE TO RELATED APPLICATION

This application claims priority to U.S. Provisional Patent Application Ser. No. 63/032,098, filed May 29, 2020, the contents of which are incorporated herein by reference in their entirety.

### GOVERNMENT LICENSE RIGHTS

This invention was made with government support under contract number DE-FE0025343 awarded by the U.S. Department of Energy. The government has certain rights in the invention.

### FIELD

This disclosure relates generally to detonation engines, and, more particularly, to detonation engines with discontinuous detonation chambers.

### BACKGROUND

Detonations are employed in a variety of pressure-gain combustion (PGC) concepts wherein shock-induced compression and heat release leads to strong local compressibility effects and an increase in total pressure. Detonation occurs at a near-constant volume because the chemical kinetics that drive the combustion are faster than the associated gas expansion processes, resulting in a combustion zone that is contained by fluid boundaries that are stationary on the timescales of the chemical reaction. Unable to expand, the heat release produces a local increase in pressure. Detonative combustion processes produce greater rates of enthalpy conversion than constant pressure deflagrations with lower associated system entropy production, which can lead to improved thermodynamic efficiency. Detonations also propagate at very high (i.e. supersonic) speeds, achieving a greater rate of reactant mass consumption than deflagrations. An increased rate of reactant mass consumption increases the thermal power density of the heat addition process.

Rotating detonation engines (RDEs) are one known mechanism for the realization of pressure gain in a viable propulsion device. RDEs operate in a “continuous spin” mode using transverse detonation propagation in an annular channel with cycle frequencies on the order of 10 kHz. Here, combustion is initiated only once, with an ignition source that either produces or promotes the growth of a shock-coupled combustion front. With an appropriate design, an implicitly dynamic injection process supports continuous unsteady operation of the combustor. However, the frontal area associated with the annular combustor and associated inlet system may be less desirable in packaging the system for some applications. For instance, external aerodynamics, thermal management, and flow control are critical for supersonic and hypersonic vehicles. The annular or cylindrical configuration required of RDEs may negatively affect the external aerodynamics, thermal management, and flow control of the vehicles on which they are installed, negating the advantages of the RDEs over conventional deflagrative combustion engines.

It would thus be desirable to provide a detonation engine that produces improved power compared to deflagrative combustion engines, and the performance of which is independent of device geometry or is not limited to a continuous geometry with a periodic boundary condition. Moreover, a detonation engine that is amenable to a wide range of vehicle configurations without negatively affecting vehicle performance or vehicle aerodynamics would be desirable.

### SUMMARY

In one embodiment, a detonation engine includes at least one chamber wall and a first detonation chamber defined by the at least one chamber wall, the first detonation chamber having a first end and a second end. The first detonation chamber is linear, curved, or includes a plurality of detonation chamber segments that are linear and/or curved, and the detonation engine is configured such that detonation repeatedly propagates from the first end of the first detonation chamber to the second end of the first detonation chamber.

In another embodiment, a vehicle includes at least one detonation engine arranged on a surface of the vehicle. Each detonation engine of the at least one detonation engine includes at least one chamber wall and a first detonation chamber defined by the at least one chamber wall. The first detonation chamber has a first end and a second end, and the first detonation chamber is linear, curved, or includes a plurality of detonation chamber segments that are linear and/or curved. The detonation engine is configured such that detonation propagates repeatedly from the first end of the first detonation chamber to the second end of the first detonation chamber.

### BRIEF DESCRIPTION OF THE DRAWINGS

FIG. 1 is a perspective view of a portion of detonation engine according to a first embodiment in which the detonation chamber is discontinuous.

FIG. 2 is a top view of a portion of the detonation engine of FIG. 1.

FIG. 3 is a cross-sectional view of the detonation chamber of FIG. 1 along line A-A of FIG. 2.

FIG. 4 is a schematic side view of the detonation chamber of the detonation engine of FIG. 1 illustrating the detonation processes in the detonation chamber.

FIG. 5 is a schematic side view of the detonation chamber of the detonation engine of FIG. 1 illustrating the detonation processes in the detonation chamber.

FIG. 6 is a schematic plan view of a detonation engine having two detonation engine sections with detonation chambers that are supplied with different fuel-oxidizer mixtures.

FIG. 7 is a top view of an aircraft illustrating locations at which the detonation engines according to FIG. 1 are arranged.

FIG. 8 is a rear view of the aircraft of FIG. 6 illustrating locations at which the detonation engines according to FIG. 1 are arranged.

FIG. 9 is a side view of the aircraft of FIG. 6 illustrating locations at which the detonation engines according to FIG. 1 are arranged.

FIG. 10 is a top view of a detonation engine having a discontinuous detonation chamber formed by two chamber segments connected by a curved transition region.

FIG. 11 is a top view of a detonation engine having a discontinuous detonation chamber formed by two chamber segments stacked one on top of the other and connected by a curved transition region.

FIG. 12 is a schematic view of a detonation engine having a plurality of discontinuous detonation chambers.

FIG. 13 is a schematic view of a detonation engine having a discontinuous detonation chamber formed by a plurality of linear chamber segments, each of which is connected by a curved transition region.

FIG. 14 is a schematic view of yet a detonation engine having a spiral-shaped discontinuous detonation chamber.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

As used herein, the term “discontinuous detonation chamber” means the detonation chamber has two ends, and does not support continuous propagation of a single detonation wave within the chamber, but instead self-generates detonation waves that travel from one end of the chamber to the other. In other words, the detonation chamber is not an annular or obround chamber around which the detonation travels continuously (e.g. a rotating detonation engine).

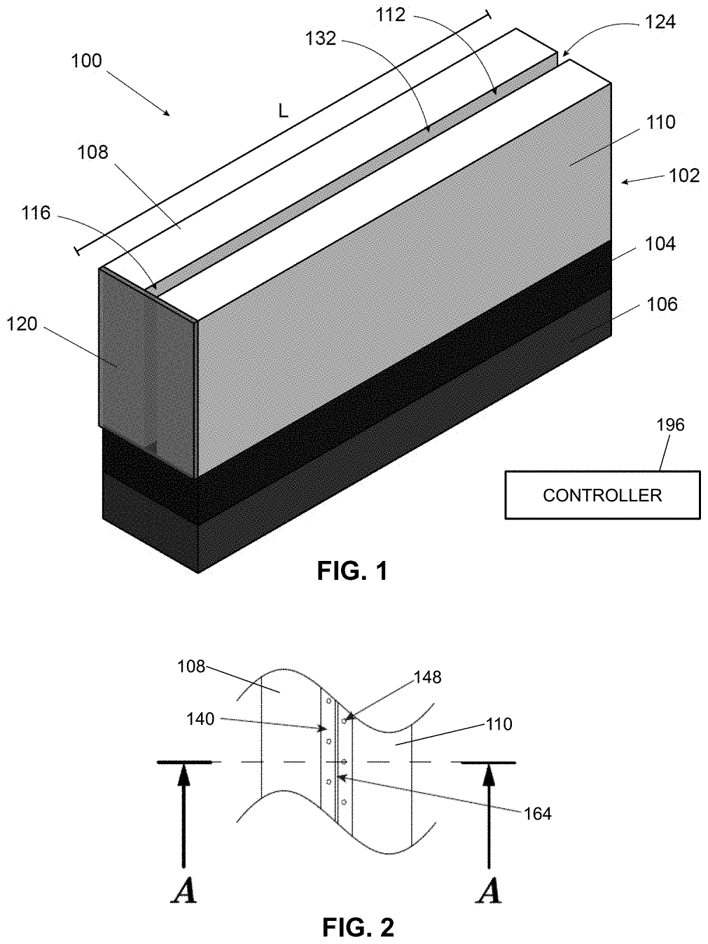

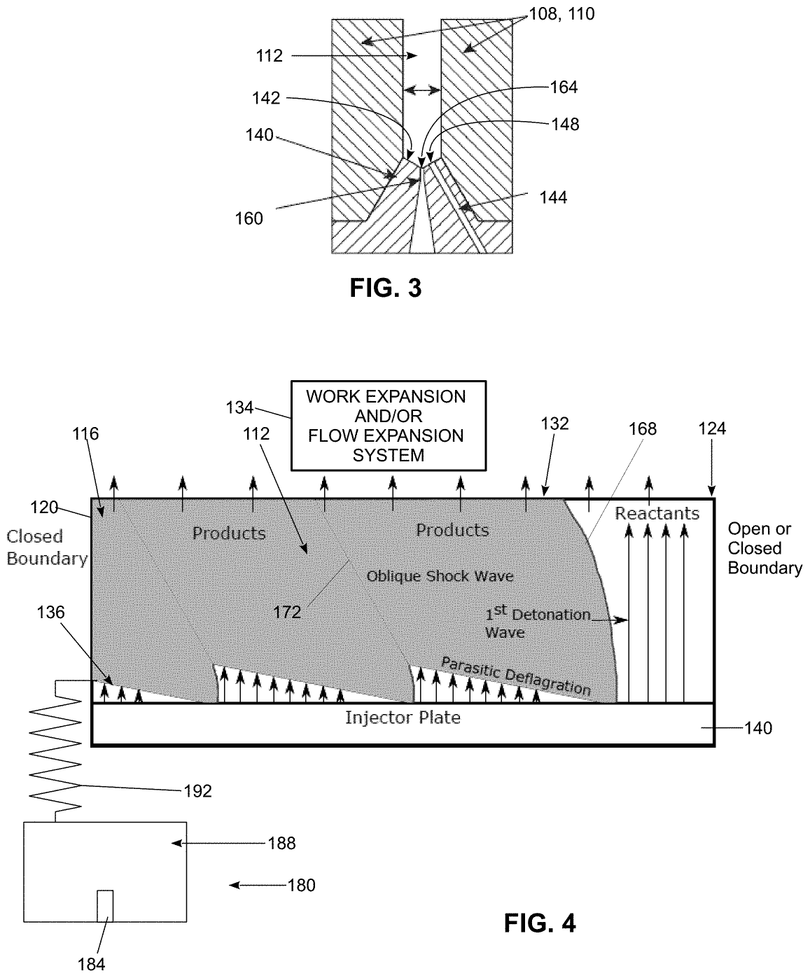

FIGS. 1-4 illustrate a portion of a detonation engine 100 that has a discontinuous detonation chamber. The detonation engine 100 includes a detonation chamber region 102, a fuel manifold 104, and an oxidizer manifold 106. The detonation chamber region 102 includes two chamber walls 108, 110 that are parallel or substantially parallel to one another, between which a detonation chamber 112 is defined. In some embodiments, the width of the detonation chamber 112 between the side walls 108, 110 may be between 5 and 10 mm. In another embodiment the detonation chamber 112 may have a width of approximately 7.62 mm. In yet another embodiment, the width of the detonation chamber may be approximately 3 times the size of the detonation cell size, which varies depending on the fuel composition, the oxidizer composition, and the mixture of fuel and oxidizer. In other embodiments, the detonation chamber may have any suitable width depending on the fuel used, the oxidizer used, and the mixture of fuel and oxidizer.

The detonation chamber 112 is closed at a first end 116 by a chamber end wall 120 such that the first end 116 has a closed boundary. In the illustrated embodiment, the second, opposite end 124 of the detonation chamber 112 has an open boundary. The reader should appreciate, however, that in some embodiments the second end 124 of the detonation chamber 112 may be closed by another chamber end wall (not shown) such that both ends 116, 124 of the detonation chamber 112 have a closed boundary. The detonation chamber 112 has a length L defined from the first end 116 to the second end 124. In some embodiments, the length L may be approximately 24 inches, though the length L may differ in other embodiments depending on the size and configuration of the detonation engine 100, and the desired thrust produced by the detonation engine 100. On an exhaust side 132, the detonation chamber 112 is open to the ambient environment or connected to a work-extraction system (e.g. a turbine) and/or flow expansion system (e.g. a nozzle) 134 in a manner generally known in the art.

The fuel manifold 104 includes an injector plate 140, which has an outer surface 142 that defines the injection side 136 of the detonation chamber 112. The outer surface 142 is angled relative to a plane defined perpendicular to the chamber walls 108, 110 and running along the axis of the detonation chamber 112. In one particular embodiment, the outer surface 142 may be angled inwardly from each chamber wall 108, 110 toward the center by approximately 30 degrees relative to the plane defined perpendicular to the chamber walls and running along the axis of the detonation chamber 112. In other embodiments, the angle of the outer surface 142 may be different depending on the mixing that is desired in the detonation chamber 112.

A plurality of fuel ducts 144 are defined in the injector plate 140, each of which terminates in an injector orifice 148 that is defined through the outer surface 142 and opens into the injection side 136 of the detonation chamber 112. The fuel ducts 144 and injector orifices 148 are evenly spaced along the length of the detonation chamber. As seen in FIG. 2, the orifices 148 alternate sides of the injector plate 140, such that the orifices 148 on one side of the detonation chamber 112 are offset from the orifices 148 on the other side so as to promote mixing of the injected fuel in the detonation chamber 112. In one particular embodiment, the injector orifices 148 may have a diameter of approximately 1.27 mm, though other size and arrangements of the injector orifices may be used in other embodiments depending on the fuel mixture and the desired mixing conditions.

Additionally, the injector plate 140 defines an oxidizer slot 160, which terminates at an oxidizer injection slot 164 that opens into the detonation chamber 112 such that the oxidizer slot 160 fluidly connects the oxidizer manifold 106 to the detonation chamber 112. In one particular embodiment, the oxidizer injection slot 164 may, for example, have a width of approximately 0.76 mm. The reader should appreciate, however, that an oxidizer injection slot of a different size or a nonuniform width may be used depending on the size and configuration of the linear detonation engine 100. The oxidizer injection may also be realized using holes instead of slots or other such arrangements depending on the oxidizer used or size and configuration of the engine and injector.

The detonation engine 100 further includes a pre-detonator 180, which includes an ignition device 184, for example a spark plug, in a pre-detonator cavity 188. The pre-detonator 180 is fluidly connected to the detonation chamber 112 by a tube 192 that includes a Shchelkin spiral to assist in the transition from deflagration combustion to detonation. The tube 192 opens into the detonation chamber 112 at the first end 116 just above the surface of the injector plate 140. In some embodiments of the detonation engine 100 with multiple detonation chambers 112, the pre-detonator 180 may include a plurality of tubes 192, each of which connects the pre-detonation cavity 188 to a respective one of the detonation chambers 112. Alternatively, the detonation engine may include any ignition device generally known in the art in place of the pre-detonator 180, for example, a torch, a laser induced spark generator, a hypergolic propellant slug, a solid propellant charge, and the like.

The detonation engine 100 is operated by a controller 196, which includes a processor that is operably connected to a memory and is configured to execute program instructions stored in the memory to operate a series of valves (not shown) to inject fuel and oxidizer into the detonation chamber, and to operate the pre-detonator to initiate a detonation.

The controller 196 operates the valves in the fuel manifold 104 to inject fuel from the fuel manifold 104, through the fuel ducts 144 and the injector orifices 148, into the detonation chamber 112. In one embodiment, the fuel for combustion is methane gas (CH₄). In other embodiments, the fuel for combustion may be hydrogen gas (H₂). In further embodiments, the fuel may be a mixture of methane and hydrogen gas. Alternatively or additionally, the fuel mixture may include or consist of other gaseous or liquid fuels, for example one or more of natural gas, propane, butane, ethanol, acetone, ethylene, RP-1, RP-2, JP-4, JP-8, JP10, or other kerosene based fuels.

In yet another embodiment, the fuel for combustion is a mixture of liquid and gaseous fuels. For example, in some embodiments, as illustrated for example in FIG. 6, a first portion of the detonation chamber is configured for injection of a gaseous fuel from a first fuel tank, and a second portion of the detonation chamber is configured for injection of a liquid fuel from a second fuel tank.

Returning now to FIGS. 1-4, at the same time as the fuel is injected, the controller 196 operates valves in the oxidizer manifold 108 to supply the oxidizer from the oxidizer manifold 108 through the oxidizer slot 160 and the oxidizer injection slot 164 into the detonation chamber 112. The oxidizer is, in some embodiments, oxygen (O₂) or a mixture of oxygen and nitrogen gas. In another embodiment, the oxidizer is ambient air. In further embodiments, the oxidizer mixture may include or consist of, for example, oxygen, either in gaseous or liquid form, air, air enriched with additional oxygen, hydrogen peroxide, or any other suitable oxidizer.

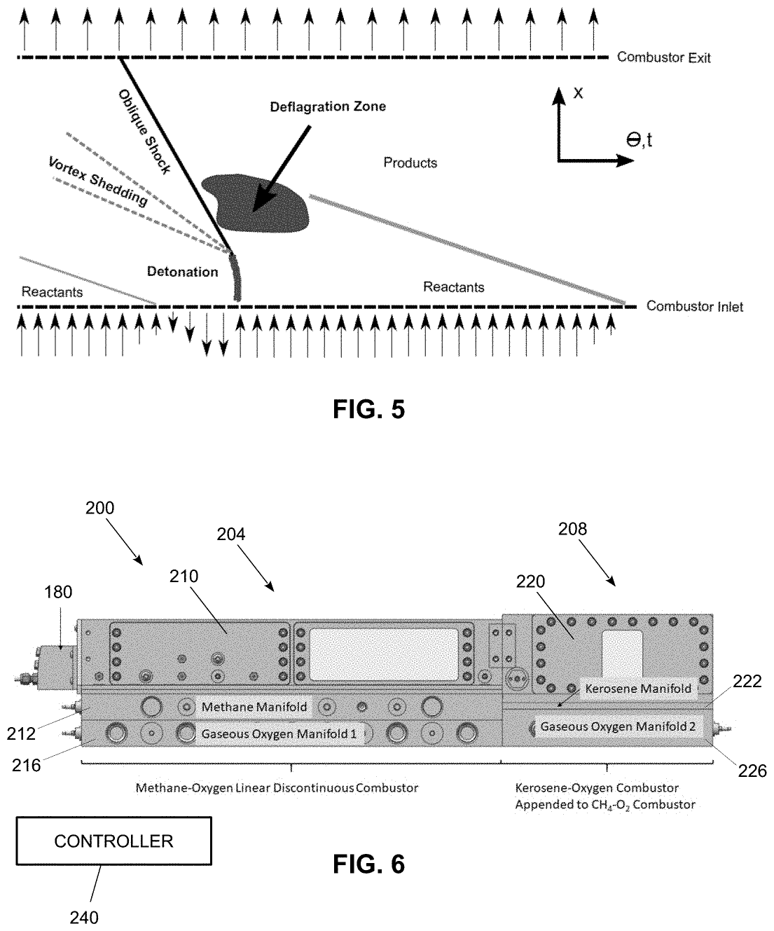

The controller 194 operates the ignition device ignites the mixture of fuel and oxidizer injected into the detonation chamber, thereby producing combustion that transitions naturally to a detonation. The detonation propagates along the length of the detonation chamber 112 from the first end 116 to the second end 124 of the detonation chamber 112, aided by continuing injection of the fuel and the oxidizer. As illustrated for example in FIGS. 4 and 5, the detonation produces a detonation wave 168 travelling from the first end 120 to the second end 124 and an oblique shockwave 172 that travels from the injector end 136 of the detonation chamber 112 outwardly to the exhaust end 132. Upon reaching the exhaust end 132, the combustion products are exhausted from the exhaust end 132, which produces thrust acting in a direction from the exhaust end 132 toward the injector end 136 (i.e. downwardly in the views of FIGS. 1, 4, and 5).

The detonation chamber 112 is configured such that a repeated deflagration to detonation transition near the first end 116 results in the regeneration and sustenance of the detonation waves in the detonation chamber 112. Thus, once initiated by a single ignition event, the detonation chamber 112 develops a steady state limit cycle in which the combustion process in the detonation chamber 112 results in pressure fluctuations that amplify and steepen into self-excited, self-sustained detonation waves. In other words, even though the detonation chamber 112 is discontinuous, detonation waves continue to propagate from the first end 116 to the second end 124 of the detonation chamber 112. These waves travel in the detonation chamber 112 until deactivation of the fuel or oxidizer supply to the detonation engine 100 without the need for additional ignition events.

The amount of thrust provided by the detonation engine 100 can be varied by modifying the quantity of fuel injected into the detonation chamber 112. In one embodiment, for example, the detonation engine 100 may be operated with a propellant mass flux of 75 kg/(s·m²) to 250 kg/(s·m²). The reader should appreciate that the range of propellant mass flux at which the detonation engine operates is dependent on the configuration of the detonation chamber and the fuels and oxidizers used, and is not limited to a range between 75 to 250 kg/(s·m²).

FIG. 6 depicts a schematic view of another detonation engine 200 in which two different fuels are used. The detonation engine includes a first detonation engine segment 204 and a second detonation engine segment 208, each of which is configured substantially similarly to the detonation engine 100 described above. The first detonation chamber segment 204 includes a first detonation chamber 206 supplied with fuel from a first fuel manifold 212, which in the illustrated embodiment is a methane manifold, and is supplied with oxidizer from a first oxidizer manifold 216, which in the illustrated embodiment is a gaseous oxygen oxidizer manifold. The second detonation engine segment 208 includes a second detonation chamber 220, which is configured as an extension of the first detonation chamber 220 and which is supplied with fuel from a second fuel manifold 222, which in the illustrated embodiment is a kerosene fuel manifold, and is supplied with oxidizer from a second oxidizer manifold 226, which in the illustrated embodiment is a second gaseous oxygen oxidizer manifold. The reader should appreciate that the oxidizer in the second oxidizer manifold 224 may be different from the oxidizer in the first oxidizer manifold 216, and any suitable fuel and oxidizer combination may be used in the first fuel and oxidizer manifolds 212, 216 and in the second fuel and oxidizer manifolds 222, 226.

The detonation engine 200 is operated by a controller 240 in a similar manner as discussed above with regard to the detonation engine 100. For example, the controller 240 operates valves in the first fuel and oxidizer manifolds 212, 216 to fill the first detonation chamber 210 with a desired mixture of fuel and oxidizer, and operates the pre-detonator 180 to produce a detonation that propagates through the first detonation engine segment 204. At the same time, the controller 240 operates valves in the second fuel and oxidizer manifolds 222, 226 to fill the second detonation chamber 220 with a desired mixture of fuel and oxidizer. The detonation from the first detonation chamber 210 continues to the second detonation chamber 220 and propagates through the second detonation chamber 220.

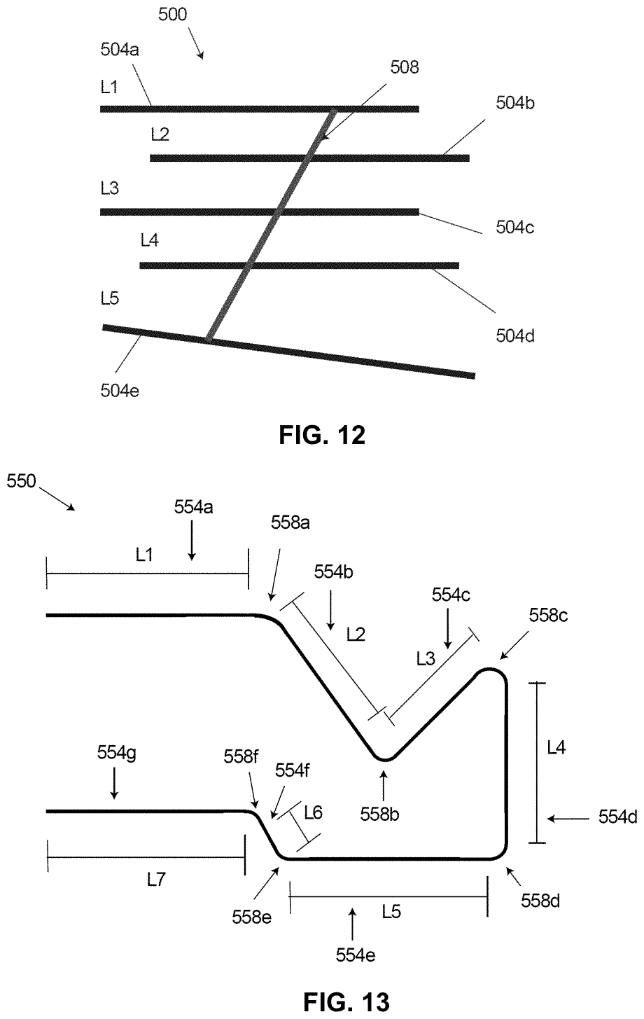

In the illustrated embodiment, the second detonation engine segment 208 is contiguous to the first detonation engine segment 204 such that the detonation chambers 210, 220 are directly connected to one another. In another embodiment, the second detonation engine segment 208 may be spaced apart from the first detonation engine segment 204 and connected via, for example, a tube, in a manner similar to the embodiment discussed below with regard to the embodiment of FIG. 12. In other embodiments, the second detonation engine segment 208 may be angled relative to the first detonation engine segment 204, and/or either or both of the first and second detonation engine segments may be configured as one or more of the detonation engines described below.

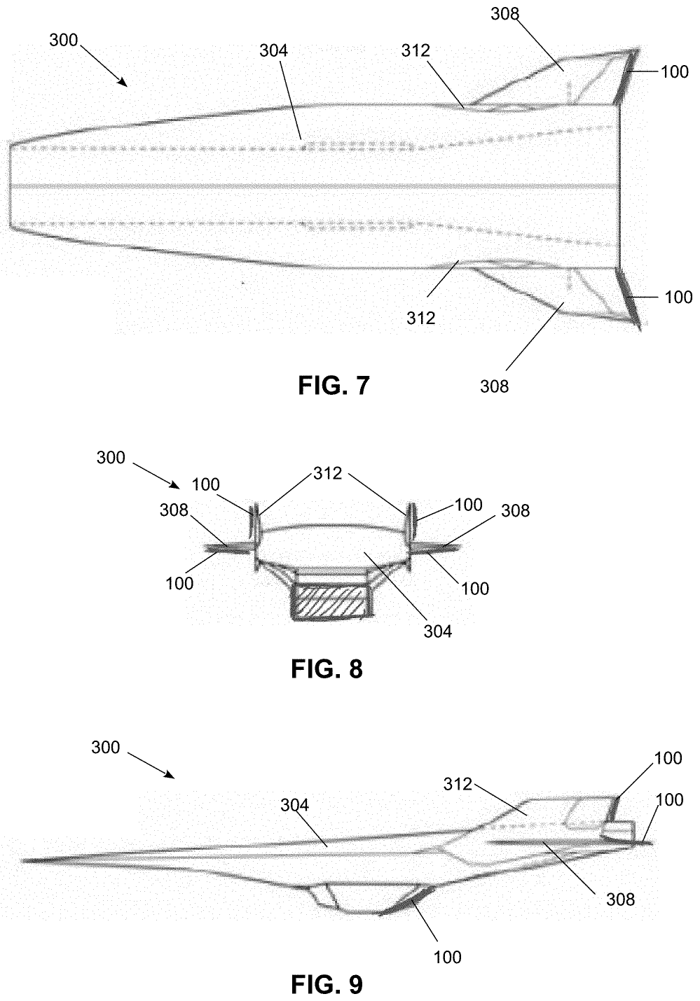

The detonation engines 100, 200 may be used in, for example, aircraft, rockets, and power-generation gas turbines. FIGS. 7-9 depict one example of a hypersonic aircraft 300 that employs one or more detonation engines 100. The aircraft 300 includes a fuselage 304, two horizontal stabilizers 308, and two vertical stabilizers 312. In addition, the aircraft 300 includes at least one detonation engine 100 oriented such that the exhaust end 132 faces generally toward the rear of the aircraft 300.

In one embodiment, for example, the aircraft 300 may include a detonation engine 100 on each horizontal stabilizer 308, for example on the rear (FIG. 7), on the bottom (FIG. 8), or on the top (FIG. 9) of the horizontal stabilizers 308, or on any combination of the rear, bottom, and/or top of the horizontal stabilizers 308. Additionally or alternatively, the aircraft may include one or more detonation engines 100 on each vertical stabilizer 312, for example on the inside, outside (FIG. 8), and/or on the rear (FIG. 9) of the vertical stabilizers 312. Additionally or alternatively, the aircraft 300 may include one or more detonation engines 100 on the fuselage 304, for example on the underside (FIG. 9), top side, and/or rear of the fuselage 304. In other embodiments, the detonation engines 100 may be arranged on the wings of an aircraft.

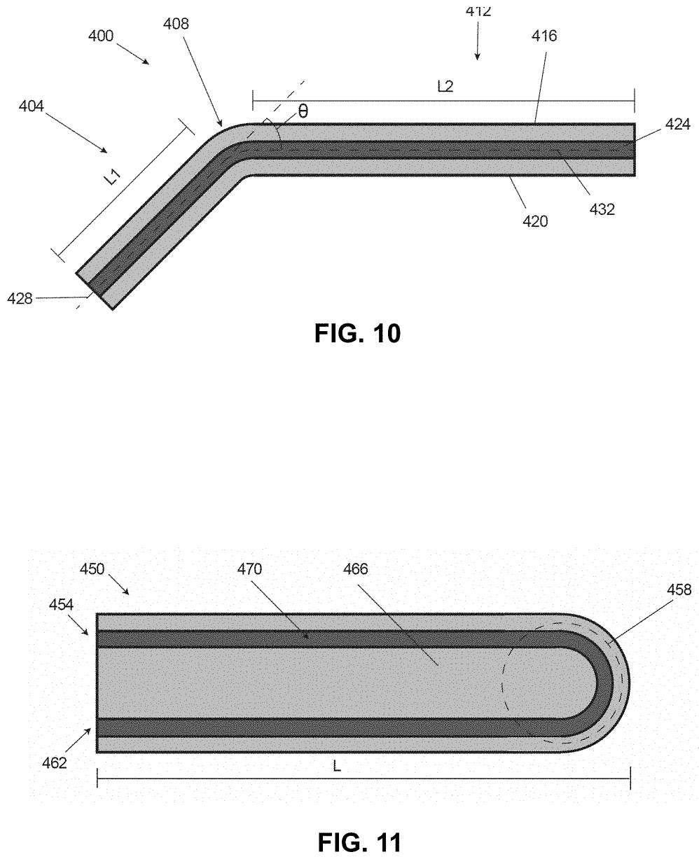

FIG. 10 depicts another embodiment of a detonation engine 400 that can be used on the aircraft 100 or another vehicle in place of the linear detonation engine 100. The detonation engine 400 includes a first linear detonation chamber segment 404, a detonation chamber transition region 408, and a second linear detonation chamber segment 412. Each of the linear segments 404 is configured substantially the same as the detonation chamber 120 of the detonation engine 100 described in detail above. In the transition region 408, the detonation chamber walls 416, 420 are curved, such that the detonation chamber 424 is also curved through the transition region 412.

The longitudinal axis 428 of the first linear segment 404 defines an angle θ relative to the longitudinal axis 432 of the second linear segment 412. The angle θ is, for example, between approximately 15° and approximately 45° in one embodiment. In another embodiment, the angle θ is approximately 30°. In other embodiments, however, the angle θ may be any desired angle depending on the configuration of the detonation engine 400 and the shape of the vehicle on which the detonation engine 400 is installed.

The curve of the detonation chamber 424 through the transition region 408 enables the detonation to propagate through the transition region 408 from the first linear segment 404 to the second linear segment 412. The nonlinear detonation engine 400 of FIG. 10 can therefore be used on a surface of the vehicle (e.g. aircraft 300) that is not planar and still generally conform to the surface of the vehicle without detonation failure in the detonation chamber 424.

FIG. 11 depicts another embodiment of a detonation engine 450 that can be used on the aircraft 300 or another vehicle in place of the linear detonation engine 100. The detonation engine 450 includes a first linear detonation chamber segment 454, a detonation chamber transition region 458, and a second linear detonation chamber section 462. The first and second linear detonation chamber segments 454, 462 are configured similarly to the detonation chamber 120 of the linear detonation engine 100 discussed above, and are stacked on one another, such that the first and second linear detonation chamber segments 454, 462 share a chamber wall 466. The reader should appreciate, however, that the chamber wall 466 may, in some embodiments, include two separate walls, each wall defining a respective one of the linear detonation segments 454, 462.

In the detonation engine 450 of FIG. 11, the detonation propagates through the detonation chamber 470 from the first linear detonation chamber segment 454, through the transition region 458, and through the second linear detonation chamber segment 462. In some embodiments, the radius of the detonation chamber 470 in the transition region 458 may be too small to support detonation within the transition region 458. Nonetheless, heated combustion products continue through the transition region 458, enabling the detonation to resume at the beginning of the second linear detonation chamber segment 462 such that the detonation propagates from the first detonation chamber segment 454 to the second detonation chamber segment 462 via the transition region 458.

The embodiment of FIG. 11 may be further modified by stacking a plurality of linear detonation segments on one other in an S-shape, with each segment being separated by a transition region, thereby forming a detonation chamber with a greater detonation length. In this manner, the embodiment of FIG. 11 can be scaled with any desired number of detonation sections stacked on one another in a compact arrangement that produces a suitable amount of thrust for the vehicle on which the detonation engine 450 is installed.

FIG. 12 is a schematic illustration of a detonation engine 500 having a plurality of linear detonation chambers 504a-e, each of which includes chamber walls (not shown) and is configured similarly to the detonation chamber 120 of the linear detonation engine 100 discussed above. The linear detonation chambers 504a-e may be parallel or at an angle relative to one another. In some embodiments, one or more of the chambers may be nonlinear, e.g. curved, and/or include multiple linear or nonlinear segments, and/or may be shaped like any of the other detonation engine chambers or chamber segments described herein.

The linear detonation chambers 504a-e are connected by a tube 508, which couples the combustion process from one of the linear detonation chambers 504a-e to the remaining linear detonation chambers 504a-e. The tube 508 may be sized and configured to maintain detonation throughout the tube 508. Alternatively, the tube 508 may in some embodiments be sized smaller than the detonation cell size of the linear chambers such that detonation is not maintained through the tube 508. The tube 508 is configured to transmit the hot combustion products from one detonation chamber 504a-e to the other detonation chambers 504a-e such that the hot combustion products from the detonation in one of the detonation chamber 504a-e initiates detonation in each of the remaining detonation chambers 504a-e, thereby propagating the detonation from one detonation chamber 504a-e to the remaining detonation chambers 504a-e.

The detonation chambers 504a-e may have any suitable length and shape. As a result, the detonation engine 500 may be spread across various surfaces of the vehicle, yet still be ignited by a single initiation event.

FIG. 13 schematically illustrates another detonation engine 550 having seven linear detonation chamber segments 554a-g, each of which is separated by a curved transition region 558a-f. The embodiment of FIG. 12 illustrates that the detonation engine according to the invention may include any suitable number of detonation chamber segments, each being separated by a transition region that propagates the detonation from one detonation chamber segment to the next by either continuing the detonation through the transition region or allowing the combustion products to carry through to initiate detonation in the subsequent detonation chamber segment. In this way, the detonation engine may extend continuously on a large portion of the surfaces of an aircraft, for example on both sides of the horizontal stabilizers, continuing onto both sides of the vertical stabilizers, and onto the fuselage, or along substantially the entire top and bottom surfaces of each wing.

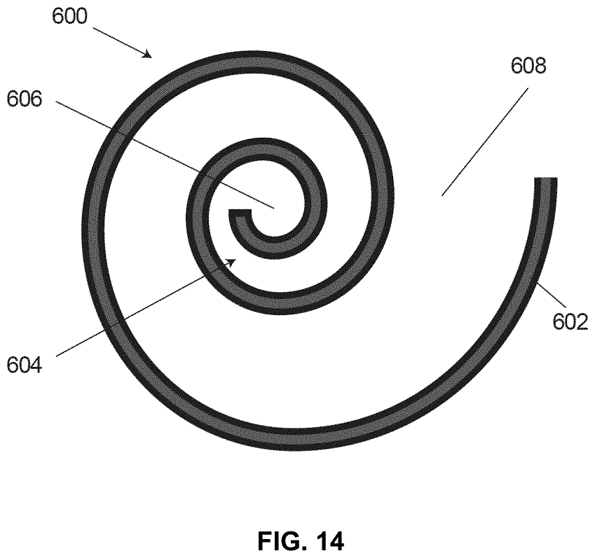

Moreover, while each of the above embodiments illustrate the detonation chambers or detonation chamber segments as being linear, the reader should appreciate that any or all of the detonation chambers or chamber segments in all of the above embodiments may be curved with a radius that can support propagation of the detonation through the detonation section. FIG. 14 illustrates one example of a curved detonation engine 600 having a spiral-shaped chamber wall 602 that forms a spiral-shaped detonation chamber 604. The spiral shaped detonation engine 600 may be configured such that the detonation commences at either the inner end 606 or the outer end 608 of the detonation chamber 604 and continues through the entire spiral to the opposite end. In a detonation engine in which the detonation chambers are nonlinear or, for example spiral-shaped, the engine can be configured compactly with a high power density or with a detonation engine that is shaped similarly to conventional jet engines, thereby enabling the detonation engine to be easily retrofitted onto existing vehicles.

The reader should appreciate that a detonation engine may combine any desired number of detonation sections or portions of the above-described detonation engines 100, 200, 400, 450, 500, 550, 600 depending on the shape, size, configuration, and function of the vehicle on which the detonation engine is installed. As a result, the detonation engine disclosed herein may be used in a wide variety of vehicles and in locations on vehicles that would not be suitable for traditional jets, ramjets, scramjets, deflagrative combustion engines, or RDEs. Furthermore, since the discontinuous detonation engine or engines are linear or can be designed in a variety of different shapes, the discontinuous detonation engine or engines may be arranged in locations that are provided for optimum propulsion dynamics, aerodynamics, thermal management, and flow control of the vehicle, reducing or eliminating the need to arrange engines at locations that are disadvantageous to the propulsion dynamics, reduce the aerodynamic efficiency, or complicate thermal management and flow control of the vehicle.

In addition, in embodiments in which the detonation engine has multiple detonation sections, the amount of thrust produced by the detonation engine can be controlled by selectively applying fuel only to certain sections of the detonation engine. As such, only desired sections of the detonation engine produce thrust, while the remaining sections are inactive. Additionally or alternatively, the propellant mass flux to each individual section of the detonation engine may be selectively tuned so as to further control the quantity and location of the thrust produced by the detonation engine and, in some instances, control the pitch or yaw of the vehicle.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the disclosure.

1. A detonation engine comprising:
at least one chamber wall; and
a first detonation chamber defined by the at least one chamber wall, the first detonation chamber having a first end and a second end,
wherein the first detonation chamber is linear, curved, or includes a plurality of detonation chamber segments that are linear and/or curved, and
wherein the detonation engine is configured such that detonation repeatedly propagates from the first end of the first detonation chamber to the second end of the first detonation chamber.

2. The detonation engine of claim 1, wherein the at least one chamber wall comprises a first chamber wall and a second chamber wall, the first and second chamber walls extending substantially parallel to one another and defining the first detonation chamber therebetween.

3. The detonation engine of claim 2, further comprising:
a fuel injector defining an injector side of the first detonation chamber and configured to inject fuel into the first detonation chamber; and
an oxidizer manifold configured to inject an oxidizer into the first detonation chamber.

4. The detonation engine of claim 3, wherein the first detonation chamber has an exhaust side that is open to the ambient environment, connected to a work extraction device, or connected to a flow expansion system.

5. The detonation engine of claim 4, further comprising a first end wall closing the first end of the first detonation chamber.

6. The detonation engine of claim 2, wherein:
the first detonation chamber comprises a first chamber segment defined by the first and second chamber walls, a second chamber segment defined by a third chamber wall, and a curved transition region connecting the first and second chamber segments, and
the detonation engine is configured such that the detonation propagates from the first chamber segment to the second chamber segment via the curved transition region.

7. The detonation engine of claim 6, wherein the first chamber segment is parallel to the second chamber segment.

8. The detonation engine of claim 6, wherein the second chamber segment is angled relative to the first chamber segment.

9. The detonation chamber of claim 1, further comprising:
a second detonation chamber that is linear, curved, or includes a plurality of detonation chamber segments that are linear and/or curved,
wherein the first detonation chamber is supplied with a first fuel-oxidizer mixture, and the second detonation chamber is supplied with a second fuel-oxidizer mixture that is different from the first fuel-oxidizer mixture, and
wherein the second detonation chamber is configured such that the detonation propagates from the first detonation chamber to the second detonation chamber.

10. The detonation engine of claim 1, further comprising:
a second detonation chamber spaced apart from the first detonation chamber; and
a combustion tube fluidly connecting the first detonation chamber to the second detonation chamber such that detonation propagates from the first detonation chamber to the second detonation chamber.

11. The detonation engine of claim 1, wherein the first detonation chamber is configured as a spiral.

12. A vehicle comprising:
at least one detonation engine arranged on a surface of the vehicle, each detonation engine of the at least one detonation engine comprising:
at least one chamber wall; and
a first detonation chamber defined by the at least one chamber wall, the first detonation chamber having a first end and a second end,
wherein the first detonation chamber is linear, curved, or includes a plurality of detonation chamber segments that are linear and/or curved, and
wherein the detonation engine is configured such that detonation repeatedly propagates from the first end of the first detonation chamber to the second end of the first detonation chamber.

13. The vehicle of claim 12, wherein the at least one chamber wall comprises a first chamber wall and a second chamber wall, the first and second chamber walls extending substantially parallel to one another and defining the first detonation chamber therebetween.

14. The vehicle of claim 13, each detonation engine further comprising:
a fuel injector defining an injector side of the first detonation chamber and configured to inject fuel into the first detonation chamber; and
an oxidizer manifold configured to inject an oxidizer into the first detonation chamber.

15. The vehicle of claim 14, each detonation engine further comprising:
at least one nozzle fluidly connected to an exhaust side of the first detonation chamber.

16. The vehicle of claim 13, wherein:
the first detonation chamber comprises a first chamber segment defined by the first and second chamber walls, a second chamber segment defined by a third chamber wall, and a curved transition region connecting the first and second chamber segments, and
the detonation engine is configured such that the detonation propagates from the first chamber segment to the second chamber segment via the curved transition region.

17. The vehicle of claim 16, wherein the first chamber segment is parallel to the second chamber segment.

18. The vehicle of claim 16, wherein the second chamber segment is angled relative to the first chamber segment.

19. The vehicle of claim 12, wherein the at least one detonation engine further comprises:
a second detonation chamber arranged on the surface of the vehicle spaced apart from the first detonation chamber; and
a combustion tube fluidly connecting the first detonation chamber to the second detonation chamber such that detonation propagates from the first detonation chamber to the second detonation chamber.

20. The vehicle of claim 12, wherein the at least one detonation engine is arranged on at least one of a horizontal stabilizer, a vertical stabilizer, a wing, and a fuselage of the vehicle.
